(19) United States
(12) Patent Application Publication
(10) Pub. No.: US 2013/0125696 A1
(43) Pub. Date: May 23, 2013

(54) ROBOT ARM ASSEMBLY

(71) Applicant: BO LONG, Shenzhen City (CN)

(72) Inventor: BO LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/595,081

(22) Filed: Aug. 27, 2012

(30) Foreign Application Priority Data
Nov. 18, 2011 (CN) 201110367720.8

(51) Int. Cl. B25J 17/00

(52) U.S. Cl. 74/490.05; 901/26; 901/28

(57) ABSTRACT

A robot arm assembly includes a first, a second, and a third hollow arm, a fourth arm, and a first, a second, and a third transmission. The second arm is rotatably connected to the first arm, the third arm is rotatably connected to the second arm, the fourth arm is rotatably connected to the third arm. The first transmission sub-assembly is rotatably received in the first arm. The second transmission sub-assembly is rotatably received in the first arm and the second arm. The third transmission sub-assembly is rotatably received in the first arm, the second arm, and the third arm, and fixedly connected to the fourth arm. The first arm, the second arm, the third arm, and the fourth arm are capable of rotating around a first axis, a second axis, a third axis, and a fourth axis respectively.

### BACKGROUND

1. Technical Field

The present disclosure relates to an industrial robot, and more particularly, to a robot arm assembly of an industrial robot.

2. Description of Related Art

An industrial robot for spraying paint or similar operation includes a plurality of arms rotatably connected to each other in order to achieve a movement around multiple axes. However, rotation angles of the arms are limited by the structures thereof and a flexibility of the arms is decreased. Thus, the efficient of the spraying is low.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an embodiment of a robot arm assembly.

FIG. 2 is a cutaway view of the robot arm assembly of FIG. 1.

### DETAILED DESCRIPTION

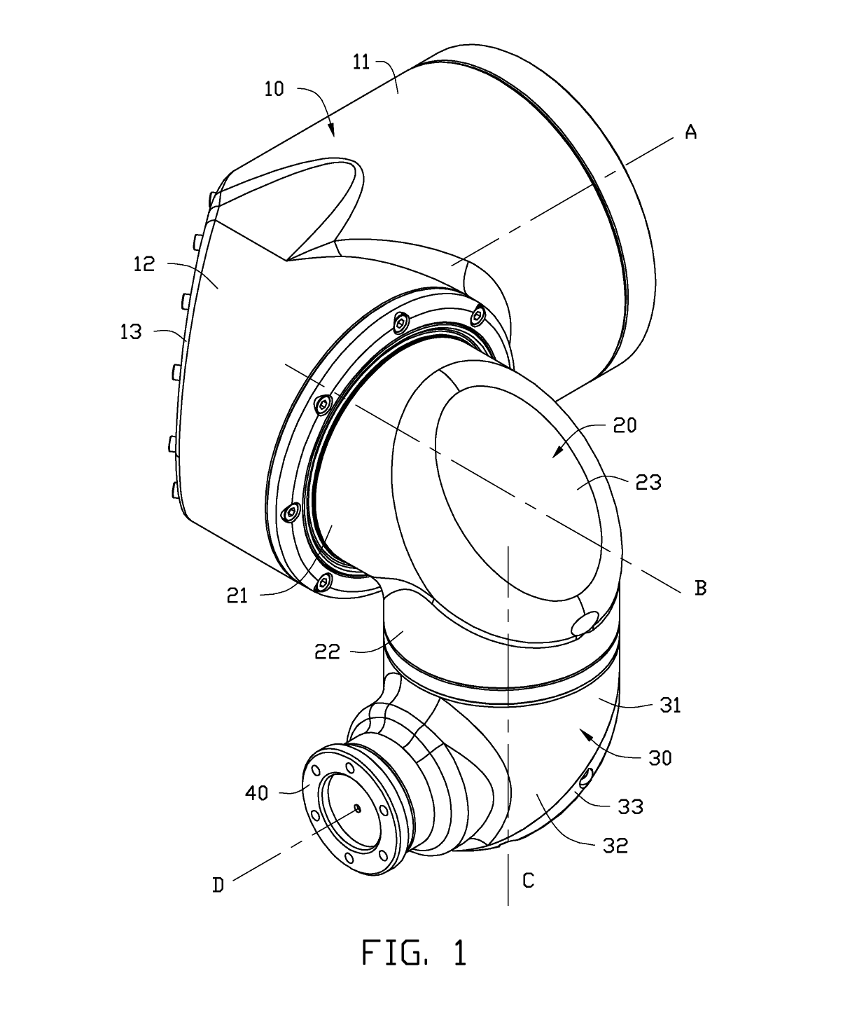

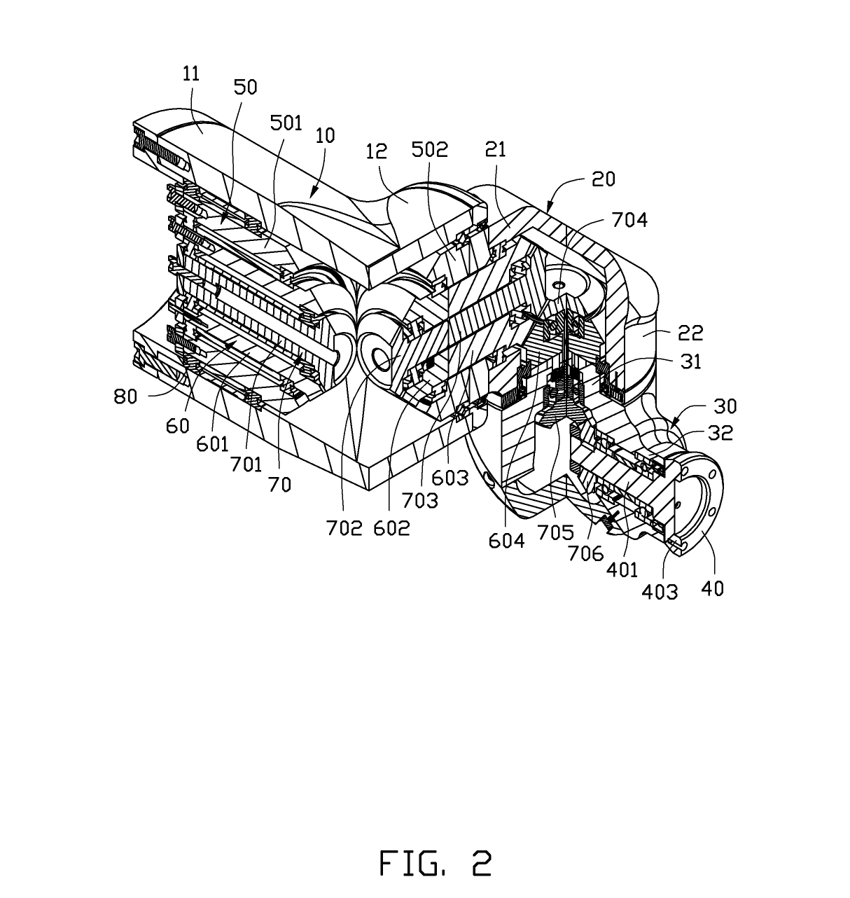

FIGS. 1 and 2 show an embodiment of a robot arm assembly 100 employed in a six-axis industrial robot. The robot arm assembly 100 includes a first arm 10, a second arm 20, a third arm 30, a fourth arm 40, a first transmission sub-assembly 50, a second transmission sub-assembly 60 and a third transmission sub-assembly 70. The first arm 10, the second arm 20, the third arm 30 and the fourth arm 40 are rotatably connected in that order. The fourth arm 40 is located at an end of the robot arm assembly 100 and equipped with an executing member, such as a gripper or spraying gun or a cutter. The first transmission sub-assembly 50 is received within the first arm 10 and capable of rotating the second arm 20. The second transmission sub-assembly 60 is received within the first arm 10 and the second arm 20, and capable of rotating the third arm 30. The third transmission sub-assembly 70 is received within the first arm 10, the second arm 20, and the third arm 30, and capable of rotating the fourth arm 40. The first arm 10, the second arm 20, the third arm 30, and the fourth arm 40 are capable of rotating around a first axis A, a second axis B, a third axis C, and a fourth axis D, respectively. The second axis B is perpendicular to the first axis A. The third axis C is perpendicular to the second axis B and to the first axis A. The fourth axis D is perpendicular to the second axis B and to the third axis C, and is spaced from the first axis A.

The first arm 10, the second arm 20, and the third arm 30 are hollow and shaped structures. The first arm 10 includes a first shaft portion 11, a second shaft portion 12, and a first cover 13. The first shaft portion 11 is arranged parallel to the first axis A, and the second shaft portion 12 is perpendicular to the first shaft portion 11. The first cover 13 is located where the first shaft portion 11 is jointed with the second shaft portion 12.

The second arm 20 includes a third shaft portion 21, a fourth shaft portion 22, and a second cover 23. The third shaft portion 21 is rotatably connected to the second shaft portion 12 of the first arm 10 and parallel to the second axis B. The fourth shaft portion 22 is perpendicular to the third shaft portion 21. The second cover 23 is located where the third shaft portion 21 is jointed with the fourth shaft portion 22.

The third arm 30 includes a fifth shaft portion 31, a sixth shaft portion 32, and a third cover 33. The fifth shaft portion 31 is arranged parallel to the third axis C, the sixth shaft portion 32 is perpendicular to the fifth shaft portion 31. The third cover 33 is located where the fifth shaft portion 31 is jointed with the sixth shaft portion 32. The fifth shaft portion 31 is rotatably connected to the fourth shaft portion 22 of the third arm 30.

The fourth arm 40 is substantially in the shape of a spindle and extends parallel to the fourth axis D. The fourth arm 40 includes a shaft 401 and a flange 403 extending from an end of the shaft 401. The shaft 401 extends though the sixth shaft portion 32 of the third arm 30, and the flange 403 abuts against an end of the sixth shaft portion 32. A gripper or spraying gun or cutter is mounted on the flange 403.

The first transmission sub-assembly 50 is received in the first arm 10, and includes a first bevel gear 501 and a second bevel gear 502. The first bevel gear 501 is rotatably received in the first shaft portion 11, the second bevel gear 502 is rotatably received in the second shaft portion 12 and perpendicularly engages with the first bevel gear 501. The second bevel gear 502 is fixed to the third shaft portion 21 of the second arm 20. In the embodiment, the first bevel gear 501 and the second bevel gear 502 have an interior void.

The second transmission sub-assembly 60 is received in the first arm 10 and the second arm 20. The second transmission sub-assembly 60 includes a third bevel gear 601, a fourth bevel gear 602, a fifth bevel gear 603, and a sixth bevel gear 604. The third bevel gear 601 is rotatably received in the first bevel gear 501. The fourth bevel gear 602 and the fifth bevel gear 603 are coaxially fixed together and rotatably received in the second bevel gear 502. The fourth bevel gear 602 perpendicularly engages with the third bevel gear 601. An end of the fifth bevel gear 603 is received in the third shaft portion 21 of the second arm 20. The sixth bevel gear 604 is rotatably received in the fourth shaft portion 22 of the second arm 20. An end of the sixth bevel gear 604 perpendicularly engages with the fifth bevel gear 603, and the opposite end of the sixth bevel gear 604 is fixed to the fifth shaft portion 31 of the third arm 30. In the embodiment, each of the third bevel gear 601, the fourth bevel gear 602, the fifth bevel gear 603, and the sixth bevel gear 604 also have an interior void.

The third transmission sub-assembly 70 is received in the first arm 10, the second arm 20, and the third arm 30. The third transmission sub-assembly 70 includes a seventh bevel gear 701, an eighth bevel gear 702, a ninth bevel gear 703, a tenth bevel gear 704, an eleventh bevel gear 705, and a twelfth bevel gear 706. The seventh bevel gear 701 is rotatably received in the third bevel gear 601. The eighth bevel gear 702 and the ninth bevel gear 703 are fixed together and rotatably received in the fourth bevel gear 602 and the fifth bevel gear 603. The eighth bevel gear 702 perpendicularly engages with the seventh bevel gear 701. The tenth bevel gear 704 and the eleventh bevel gear 705 are coaxially fixed together. The tenth bevel gear 704 is received in the sixth bevel gear 604 and perpendicularly engages with the ninth bevel gear 703. The eleventh bevel gear 705 is rotatably received in the fifth shaft portion 31 of the third arm 30. The twelfth bevel gear 706 is rotatably received in the sixth shaft portion 32 of the third arm 30 and fixedly sleeved on the shaft 401 of the fourth arm 40. The twelfth bevel gear 706 perpendicularly engages with the eleventh gear 705.

A plurality of bearings 80 are employed in the robot arm assembly 100 to reduce friction and promote precision. The plurality of bearings 80 are mounted between the first arm 10 and the first transmission sub-assembly 50, between the second arm 20 and the second transmission sub-assembly 60, between the third arm 30 and the third transmission sub-assembly 70, between the first transmission sub-assembly 50 and the second transmission sub-assembly 60, and between the second transmission sub-assembly 60 and the third transmission sub-assembly 70. The type of the bearings 80 may be selected as needed.

The robot arm assembly 100 further includes a driving sub-assembly (not shown) mounted on an end of the first arm 10 away from the second arm 20. The driving sub-assembly includes a first driving unit, a second driving unit, a third driving unit, and a fourth driving unit. The first driving unit is connected to the first arm and capable of rotating the first arm 10 around the first axis A. The second driving unit is connected to the first bevel gear 501 and capable of rotating the second arm 20 around the second axis B via the second bevel gear 502. The third driving unit is connected to the third bevel gear 601 and capable of rotating the third arm 30 around the third axis C via the fourth bevel gear 602, the fifth bevel gear 603, and the sixth bevel gear 604. The fourth driving unit is connected to the seventh bevel gear 701 and capable of rotating the fourth arm 40 around the fourth axis D via the eighth bevel gear 702, the ninth bevel gear 703, the tenth bevel gear 704, the eleventh bevel gear 705, and the twelfth bevel gear 706.

In assembly, the second arm 20 is rotatably connected to the first arm 10, the third arm 30 is rotatably connected to the second arm 20, and the fourth arm 40 rotatably extends into the third arm 30. The third transmission sub-assembly 70 is received within the first arm 10, the second arm 20, and the third arm 30, and connected to the fourth arm. The second transmission sub-assembly 60 is sleeved on the third transmission sub-assembly 70 and received in the first arm 10 and the second arm 20, and is connected to the third arm 30. The first transmission sub-assembly 50 is sleeved on the second transmission sub-assembly 60 and received within the first arm 10 and connected to the second arm 20.

In use, the first driving unit rotates the first arm 10, the second arm 20, the third arm 30, and the fourth arm 40 around the first axis A. The second driving unit rotates the second arm 20, the third arm 30, and the fourth arm 40 around the second axis B via the first bevel gear 501 and the second bevel gear 502. The third driving unit rotates the third arm 30 and the fourth arm 40 around the third axis C via the third bevel gear 601, the fourth bevel gear 602, the fifth bevel gear 603, and the sixth bevel gear 604. The fourth driving unit rotates the fourth arm 40 around the fourth axis D via the seventh bevel gear 701, the eighth bevel gear 702, the ninth bevel gear 703, the tenth bevel gear 704, the eleventh bevel gear 705, and the twelfth bevel gear 706. The fourth arm 40 drives the executing member to rotate.

While various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A robot arm assembly, comprising:
a hollow first arm capable of rotating around a first axis;
a hollow second arm rotatably connected to the first arm;
a hollow third arm rotatably connected to the second arm;
a fourth arm rotatably connected to the third arm;
a first transmission sub-assembly rotatably received in the first arm and fixedly connected to the second arm for rotating the second arm around a second axis perpendicular to the first axis;
a second transmission sub-assembly rotatably received in the first arm and the second arms, and fixedly connected to the third arm for rotating the third arm around a third axis perpendicular to the first axis and the second axis; and
a third transmission sub-assembly rotatably received in the first arm, the second arm, and the third arm and fixedly connected to the fourth arm for rotating the fourth arm around a fourth axis perpendicular to the second axis and the third axis, wherein the fourth axis is spaced from the first axis.

2. The robot arm assembly of claim 1, wherein the first arm comprises a first shaft portion, a second shaft portion, and a first cover, the first shaft portion is arranged parallel to the first axis, the second shaft portion is perpendicular to the first shaft portion, the first cover is located where the first shaft portion jointing with the second shaft portion, and the second arm is connected to the first arm via the second shaft portion.

3. The robot arm assembly of claim 2, wherein the second arm comprises a third shaft portion, a fourth shaft portion, and a second cover, the third shaft portion is arranged parallel to the second axis, the fourth shaft portion is perpendicular to the third shaft portion, the second cover is located where the third shaft portion jointing with the fourth shaft portion, and the third shaft portion is rotatably connected to the second shaft portion of the first arm.

4. The robot arm assembly of claim 3, wherein the third arm comprises a fifth shaft portion, a sixth shaft portion, and a third cover, the fifth shaft portion is arranged parallel to the third axis, the sixth shaft portion is perpendicular to the fifth shaft portion, the third cover is located where the fifth shaft portion jointing with the sixth shaft portion, and the fifth shaft portion is rotatably connected to the fourth shaft portion of the third arm.

5. The robot arm assembly of claim 4, wherein the fourth arm is substantially in a spindle shape and extends parallel to the fourth axis, the fourth arm comprises a shaft and a flange extending from an end of the shaft, the shaft extends though the sixth shaft portion of the third arm, and the flange abuts against an end of the sixth shaft portion.

6. The robot arm assembly of claim 4, wherein the first transmission sub-assembly comprises a first bevel gear and a second bevel gear, the first bevel gear is rotatably received in the first shaft portion, the second bevel gear is rotatably received in the second shaft portion and perpendicularly engages with the first bevel gear, an end of the second bevel gear is fixed to the third shaft portion of the second arm, and the first bevel gear and the second bevel gear are hollow.

7. The robot arm assembly of claim 6, wherein the second transmission sub-assembly comprises a third bevel gear, a fourth bevel gear, a fifth bevel gear, and a sixth bevel gear, the third bevel gear is rotatably received in the first bevel gear, the fourth bevel gear and the fifth bevel gear are coaxially fixed together and rotatably received in the second bevel gear, the fourth bevel gear perpendicularly engages with the third bevel gear, an end of the fifth bevel gear is received in the third shaft portion, the sixth bevel gear is rotatably received in the fourth shaft portion, a first end of the sixth bevel gear perpendicularly engages with the fifth bevel gear, a second end of the sixth bevel gear opposite to the first end is fixedly connected to the fifth shaft portion of the third arm, and the third bevel gear, the fourth bevel gear, the fifth bevel gear, and the sixth bevel gear are hollow.

8. The robot arm assembly of claim 7, wherein the third transmission sub-assembly comprises a seventh bevel gear, a eighth bevel gear, a ninth bevel gear, a tenth bevel gear, a eleventh bevel gear, and a twelfth bevel gear, the seventh bevel gear is rotatably received in the third bevel gear, the eighth bevel gear and the ninth bevel gear are fixed together and rotatably received in the fourth bevel gear and the fifth bevel gear, the eighth bevel gear perpendicularly engages with the seventh bevel gear, the tenth bevel gear and the eleventh bevel gear are coaxially fixed together, the tenth bevel gear perpendicularly engages with the ninth bevel gear, the twelfth bevel gear is rotatably received in the sixth shaft portion of the third arm and fixedly sleeved on fourth arm, and the twelfth bevel gear perpendicularly engages with the eleventh gear.

9. The robot arm assembly of claim 8, wherein the tenth bevel gear is received in the sixth bevel gear, and the eleventh bevel gear is rotatably received in the fifth shaft portion of the third arm.

10. A robot arm assembly, comprising:
a hollow first arm capable of rotating around a first axis;
a hollow second arm rotatably connected to the first arm;
a hollow third arm rotatably connected to the second arm;
a fourth arm substantially in a spindle shape, where in the fourth arm comprises a shaft and a flange extending from an end of the shaft, the shaft rotatably received in the third arm;
a first transmission sub-assembly rotatably received in the first arm and fixedly connected to the second arm for rotating the second arm around a second axis;
a second transmission sub-assembly rotatably received in the first arm and the second arms, and fixedly connected to the third arm for rotating the third arm around a third axis; and
a third transmission sub-assembly rotatably received in the first arm, the second arm and the third arm and fixedly connected to the shaft of the fourth arm for rotating the fourth arm around a fourth axis.

11. The robot arm assembly of claim 10, wherein the first arm comprises a first shaft portion, a second shaft portion, and a first cover, the first shaft portion is arranged parallel to the first axis, the second shaft portion is perpendicular to the first shaft portion, the first cover is located where the first shaft portion jointing with the second shaft portion, and the second arm is connected to the first arm via the second shaft portion.

12. The robot arm assembly of claim 11, wherein the second arm comprises a third shaft portion, a fourth shaft portion, and a second cover, the third shaft portion is arranged parallel to the second axis, the fourth shaft portion is perpendicular to the third shaft portion, the second cover is located where the third shaft portion jointing with the fourth shaft portion, and the third shaft portion is rotatably connected to the second shaft portion of the first arm.

13. The robot arm assembly of claim 12, wherein the third arm comprises a fifth shaft portion, a sixth shaft portion, and a third cover, the fifth shaft portion is arranged parallel to the third axis, the sixth shaft portion is perpendicular to the fifth shaft portion, the third cover is located where the fifth shaft portion jointing with the sixth shaft portion, and the fifth shaft portion is rotatably connected to the fourth shaft portion of the third arm.

14. The robot arm assembly of claim 13, wherein the second axis is perpendicular to the first axis, the third axis is perpendicular to the first axis and the second axis, the fourth axis is perpendicular to the second axis and the third axis and spaced from the first axis, and the first shaft portion of the first arm is arranged parallel to the first axis.

15. The robot arm assembly of claim 14, wherein the first transmission sub-assembly comprises a first bevel gear and a second bevel gear, the first bevel gear is rotatably received in the first shaft portion, the second bevel gear is rotatably received in the second shaft portion and perpendicularly engages with the first bevel gear, an end of the second bevel gear is fixed to the third shaft portion of the second arm, and the first bevel gear and the second bevel gear are hollow.

16. The robot arm assembly of claim 15, wherein the second transmission sub-assembly comprises a third bevel gear, a fourth bevel gear, a fifth bevel gear, and a sixth bevel gear, the third bevel gear is rotatably received in the first bevel gear, the fourth bevel gear and the fifth bevel gear are coaxially fixed together and rotatably received in the second bevel gear, the fourth bevel gear perpendicularly engages with the third bevel gear, an end of the fifth bevel gear is received in the third shaft portion, the sixth bevel gear is rotatably received in the fourth shaft portion, a first end of the sixth bevel gear perpendicularly engages with the fifth bevel gear, a second end of the sixth bevel gear opposite to the first end is fixedly connected to the fifth shaft portion of the third arm, and the third bevel gear, the fourth bevel gear, the fifth bevel gear, and the sixth bevel gear are hollow.

17. The robot arm assembly of claim 16, wherein the third transmission sub-assembly comprises a seventh bevel gear, a eighth bevel gear, a ninth bevel gear, a tenth bevel gear, a eleventh bevel gear, and a twelfth bevel gear, the seventh bevel gear is rotatably received in the third bevel gear, the eighth bevel gear and the ninth bevel gear are fixed together and rotatably received in the fourth bevel gear and the fifth bevel gear, the eighth bevel gear perpendicularly engages with the seventh bevel gear, the tenth bevel gear and the eleventh bevel gear are coaxially fixed together, the tenth bevel gear perpendicularly engages with the ninth bevel gear, the twelfth bevel gear is rotatably received in the sixth shaft portion of the third arm and fixedly sleeved on fourth arm, and the twelfth bevel gear perpendicularly engages with the eleventh gear.

18. The robot arm assembly of claim 17, wherein the tenth bevel gear is received in the sixth bevel gear, and the eleventh bevel gear is rotatably received in the fifth shaft portion of the third arm.
